(19) United States
(12) Patent Application Publication
(10) Pub. No.: US 2007/0000587 A1
(43) Pub. Date: Jan. 4, 2007

(54) Run-flat assembly comprising a foam insert and improved airtight membranes

(75) Inventors: Philippe Tramond, St-Ours-Les-Roches (FR); Martial Fayol, Volvic (FR); Gerard Bor, La-Roche Noire (FR); Noel Morel, Enval (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/479,218

(22) Filed: Jun. 30, 2006

(30) Foreign Application Priority Data
Jun. 30, 2005 (FR) 05/06751

(51) Int. Cl. B60C 17/06

(52) U.S. Cl. 152/158; 152/520; 152/339.1

(57) ABSTRACT

An assembly (1) formed of a wheel comprising a rim (3) equipped with an inflation valve (4), a tire (2) mounted on said rim (3) of said wheel, and a foam insert (5) placed inside the volume defined by the internal wall of the tire (2) and the wheel rim (3). The foam insert (5) is disposed in a first compartment (A) in communication with the atmosphere via a duct (36) and isolated in airtight manner by a flexible membrane (51) from the rest of the space (B) inside the tire casing, which space forms a second compartment (B) in communication with the inflation valve (4, 41) and designed to be inflated to the utilisation pressure of the tire. At least one of the edges of the membrane (52a, 52b) forms an airtight joint with the rim (3) along a circular bearing surface (32a, 32b), separate from the rim seats (31a, 31b) designed to receive the beads (21a, 21) of the tire (2), and situated axially inside the space between each of the seats (31a, 31b) and the sidewall of the foam insert (50a, 50b) positioned opposite said seat.

### FIELD OF THE INVENTION

The invention relates to run flat assemblies intended to be fitted on motor vehicles. These assemblies comprise a rim equipped with a valve and a tire, and enclose an insert approximately toroidal in shape. This insert, more commonly known as a foam insert, is generally made of closed-cell cellular rubber. It is designed to bear the load in the event of the tire losing pressure. The cells may, in some cases, contain a pressurised gas.

### BACKGROUND OF THE INVENTION

Safety devices of this type are known from the prior art and numerous variant embodiments have been proposed. One of them is disclosed in patent FR 1 450 638, which explains the operating principle thereof and describes the behaviour of the insert under the effect of centrifugal force. This publication proposes to improve the stability of the foam insert on the rim, by bringing the radially inner face of the insert into contact with atmospheric pressure and causing the inflation pressure to act on the radially outer face of this insert.

In order to achieve this effect, it is proposed to isolate the foam insert in a first compartment in communication with the atmosphere by means of a flexible, airtight membrane forming a partition with a second compartment brought to utilisation pressure.

The difference in pressure between the two compartments produces a radially inwardly directed force acting on the insert and having the effect of flattening said insert on the rim by compressing the gas contained in the cells. The action of the inflation pressure also has the consequence of reducing the volume of said insert, which makes it possible to avoid all contact between the internal wall of the crown of the tire and the foam insert. This force also opposes the centrifugal force and assists in holding the insert in position against the rim when the vehicle reaches an elevated speed.

When the pressure in the tire casing falls below a certain threshold, the foam insert resumes its natural shape and occupies all the internal volume of the tire casing, so contributing to support of the tire.

This same patent also describes a particular embodiment of the valve which is designed so as to allow the first compartment to communicate with the atmosphere and the second compartment to be inflated to tire utilisation pressure.

Also known from the above-mentioned publication are arrangements of the membrane in which said membrane is anchored either:

by adhesion of one of the edges of the membrane to the sidewall of the foam insert and of the other edge to the inner part of the bead of the tire; a variant of this technical suggestion consists in extending the edges of the membrane along the internal wall of the tire casing or around the foam insert so as to eliminate the problems of adhesion to the sidewall of the foam insert, or

by simple interposition of the edge of the membrane between the seat of the rim and the bead of the tire casing.

However, although these technical solutions satisfactorily fulfil the sought-after separating function, they exhibit several disadvantages, which include:

the difficulty of positioning the inflation valve, which is associated with the need to pass through the membrane while keeping it airtight, so as to introduce inflation air into the second compartment,

modification of the diameters of the rim or the bead so as to make it possible to interpose the membrane between the rim seat and the bead, resulting in destandardisation of these components.

### SUMMARY OF THE INVENTION

The object of the present invention is to propose improved embodiments for anchoring the edge of the membrane, allowing elimination of the problems stated above.

It relates to assemblies formed of a wheel comprising a rim equipped with an inflation valve, a tire mounted on said rim of said wheel, and a foam insert placed inside the volume defined by the internal wall of the tire and the wheel rim, in which the foam insert is disposed in a first compartment (A) in communication with the atmosphere by means of a duct and isolated by an airtight membrane from the rest of the space inside the tire casing, which forms a second airtight compartment (B) in communication with the inflation valve and inflated to the utilisation pressure of the tire.

According to the invention, the membrane forms an airtight joint directly with the rim.

To this end, the rim comprises at least one circular bearing surface, separate from the rim seats designed to receive the beads of the tire and situated axially inside the space between the two seats. The circular bearing surface is situated substantially in the vicinity of said rim seats in the space located axially between each of the rim seats and the zone of the rim designed to receive the foam insert. At least one of the edges of the membrane forms an airtight joint with the circular bearing surface.

Anchoring of the membrane is effected directly on the rim, it being possible to dispose the air inlet duct of the valve such that it opens directly from the rim into the second compartment, so avoiding any passage through said membrane. Thus, the mounting and demounting operations therefor are greatly simplified. Furthermore, it is not necessary to modify the diameters of the rim seat, nor that of the tire, since the circular bearing surface on which the edge of the membrane rests in airtight manner is distinct from the seat on which rests the bead of the tire.

So as to increase the effect associated with the pressure on the foam insert, it is worthwhile arranging anchoring of the membranes on the rim as close as possible to the seats intended to receive the tire beads so as to benefit from the largest possible area of support for the insert on the rim.

The shape and arrangement of the edge of the airtight membrane in contact with the rim may be embodied in various ways according to the invention, which various embodiments will be better understood from the description made with reference to FIGS. 1 to 8.

### BRIEF DESCRIPTION OF THE DRAWINGS

FIG. 1 is a view in radial section of an assembly according to the invention in inflated mode,

FIG. 2 is a view in radial section of a variant embodiment of the previous assembly comprising a membrane separated into two parts,

FIG. 3 is a view in radial section of the previous assembly in deflated mode,

FIG. 4 is a view in radial section of a first variant embodiment of the invention in which one of the two edges of the membrane is adhesively bonded against the inner part of the bead of the tire,

FIGS. 5, 6 and 7 are views in radial section of various variant embodiments of the joint between the edge of the membrane and the rim,

FIG. 8 is a view in radial section of a variant embodiment of the invention on a rim with an inwardly oriented seat.

### DETAILED DESCRIPTION OF THE DRAWINGS

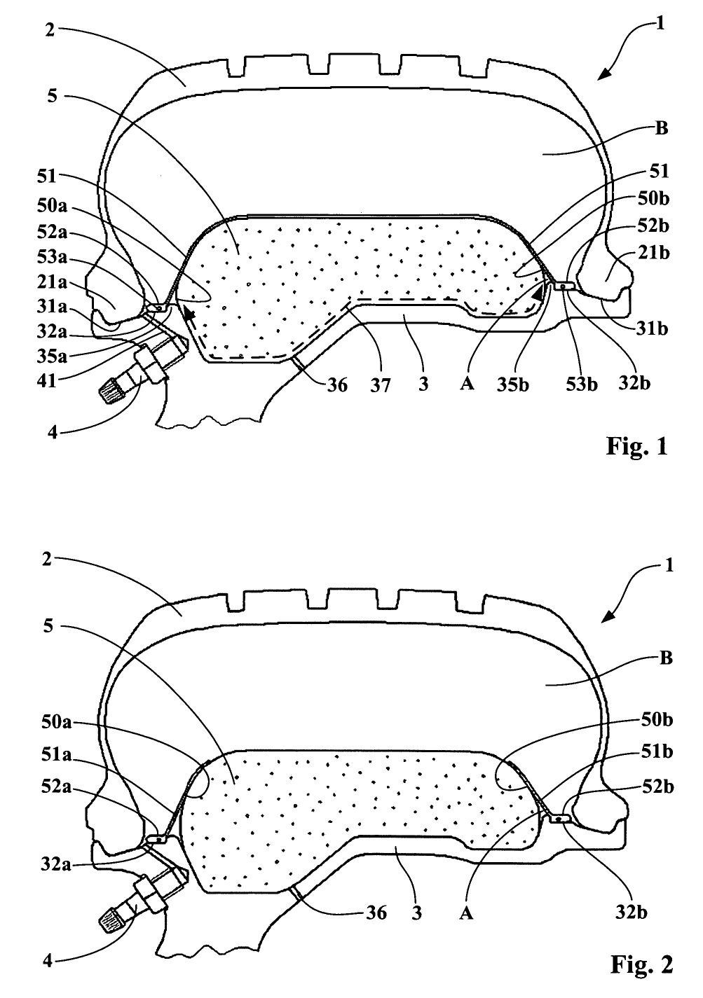

The assembly 1, shown in FIG. 1, is formed of a wheel comprising a rim 3 equipped with a valve 4, a tire 2 mounted on the rim 3 and a foam insert 5, placed in the internal space defined by the internal wall of the tire 2 and the rim 3 of the wheel. The beads 21a and 21b of the tire 2 rest on the seats 31a and 31b of the rim 3. An airtight membrane 51 substantially toroidal in form is arranged so as to ensure separation between the two compartments A and B.

The membrane 51 is placed on the radially upper part of the foam insert 5. The edges 52a and 52b of the membrane 51 rest on the circular bearing surfaces 32a and 32b formed on the rim 3. The circular bearing surfaces 32a and 32b are situated axially in the space between the seats 31a and 31b. Each of the circular bearing surfaces 32a and 32b is placed axially in the space between the rim seat, respectively 31a and 31b, and the zone 37 of the rim 3 intended to receive the foam insert. This zone 37, shown by a broken line in FIG. 1, corresponds to the contact zone between the rim and the foam insert.

The membrane 51 thus makes it possible to isolate compartments A and B in airtight manner.

Compartment A is in communication with atmospheric pressure via the orifice 36. The valve 4 is extended by a duct 41 allowing pressurised air to be introduced into compartment B. It will be noted that this particular arrangement of the membrane 51 allows the outlet of the duct 41 to be brought into direct communication with the second compartment B without the need to provide a means allowing passage through said membrane.

FIG. 2 shows a variant embodiment of the membrane, according to which the membrane 51 is separated into two parts 51a and 51b whose axially inner edges are adhesively bonded in airtight manner respectively to each of the sidewalls 50a, 50b of the foam insert 50. It will be noted that, under these conditions, it is necessary for the external wall itself of the foam insert to be airtight, such that the air contained in compartment B cannot diffuse through the foam insert. This technical effect is generally obtained by using polybutadiene-based materials, as are commonly used to produce said foam inserts.

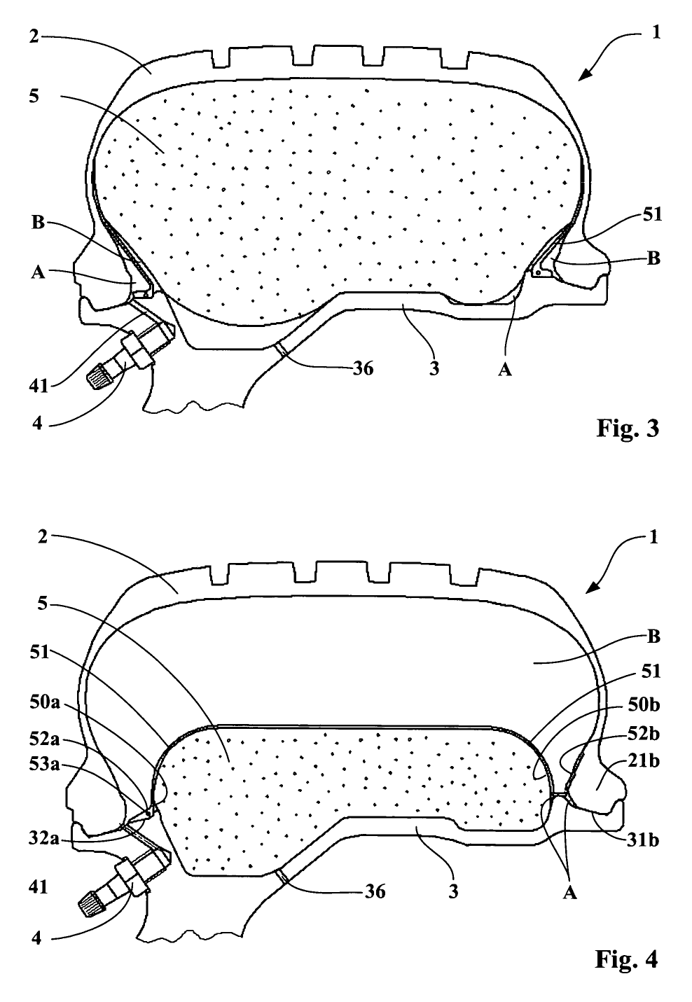

Pressurisation of compartment B causes compression of the foam insert 5, as illustrated in FIG. 1 or 2. Compartment A remains at atmospheric pressure. FIG. 3 illustrates what happens when pressure is lost in the second compartment B. The foam insert 5 then takes up all the volume of the internal space.

It will be noted that it is necessary for the membrane 51 to be able to deploy sufficiently to be able to be flattened against the internal wall of the tire 2 and not to impede expansion of the foam insert. This effect is obtained by making the membrane of a flexible and resilient material or, alternatively by using a material which is flexible but not resilient. In this second configuration, the size of the membrane has to be conformed to the size of the inner surface of the tire.

The airtight seal between the edges 52a and 52b of the membrane 51 and the circular bearing surface 32a, 32b is ensured by adhering or clamping said edges to the circular bearing surface, the latter arrangement being preferable due to the ease with which it may be implemented and the fact that it may be dismantled.

Clamping of the edges 52a and 52b of the membrane 51 to the bearing surfaces 32a and 32b may be improved by incorporating a circular reinforcement 53a, 53b into the edge 52a, 52b of the membrane 51. This circular reinforcement 53a, 53b may take the form of one or more textile or metallic reinforcement cords exhibiting high yield strength. It is also possible to make the bearing surfaces 32a and 32b slightly tapered so as to assist in clamping.

It may also be advisable to provide limit stops 35a and 35b, which make it possible to limit axial displacement of the edges 52a and 52b of the membrane, which would be liable to cause a loss of airtightness.

FIG. 4 shows another arrangement in which only one edge 52a of the membrane 51 is joined to the rim in airtight manner. The other edge 52b of the membrane 51 is adhesively bonded to the internal wall of the bead 21b of the tire 2. It is preferable to adhere the opposite edge 52b of the membrane 51 from the edge where the inflation valve 4 is situated, so as to allow the orifice 41 to lead directly into the second compartment B. This embodiment may prove worthwhile with regard to facilitating the mounting and demounting operation.

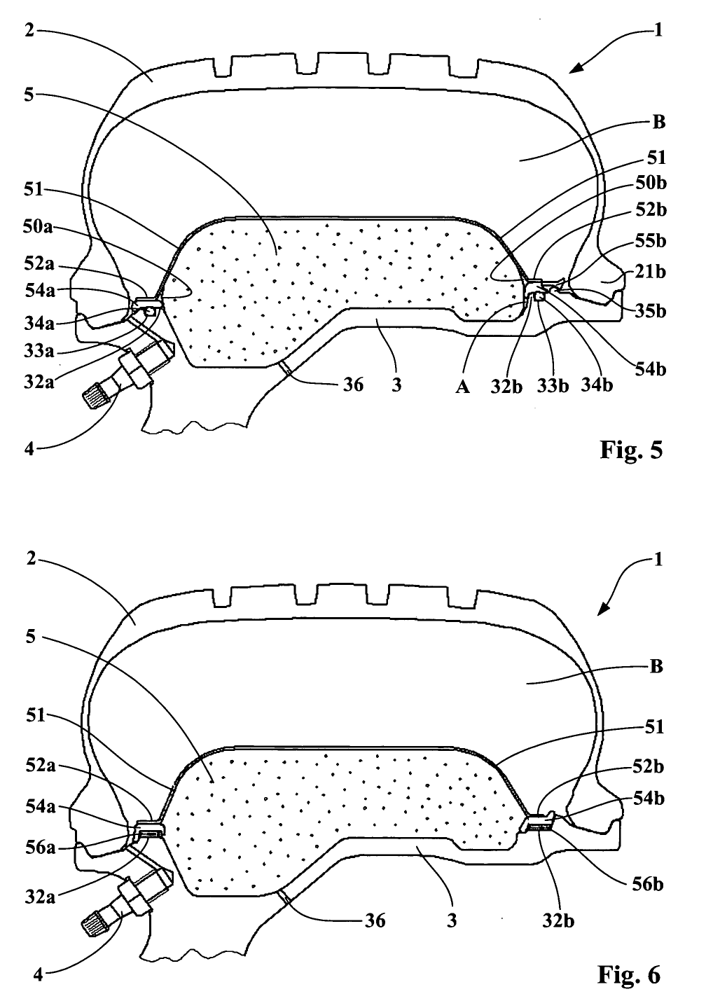

The airtight joint between the edges 51a, 51b of the membrane 51 and the circular bearing surfaces 32a, 32b may also be the subject of variant embodiments of the invention illustrated in FIGS. 5, 6 and 7.

FIG. 5 illustrates a case in which the edge 52a, 52b is adhesively bonded to the radially upper bearing surface of a circular ring 54a, 54b. This circular ring plays both a reinforcing and a joining role. The circular bearing surface 32a, 32b comprises a groove 33a, 33b in which is disposed an O-ring seal 34a, 34b. The diameter of the radially lower bearing surface of the circular ring is adjusted to form an airtight joint with the O-ring seal 34a, 34b.

It will also be noted that a different embodiment is provided for the limit stop 35b, in which the circular ring 54b comprises a clip 55b fastened to a limit stop 35b situated axially to the outside of the bearing surface 32b. The clip 55b, while making it possible to limit the axial travel of the edge 52b of the membrane 51, is carried along by the movement of the bead 21b during the demounting operation, which renders this operation all the easier.

FIG. 6 proposes a second variant embodiment of the airtight joint, in which the edge 52a, 52b of the membrane 51 is also adhesively bonded to the radially upper bearing surface of the circular ring 54a, 54b. Said circular ring 54a, 54b comprises a circular gasket 56a, 56b fixed to its radially inner bearing surface. The function of the gasket 54a, 54b is to ensure an airtight seal by clamping to the circular bearing surface 32a, 32b.

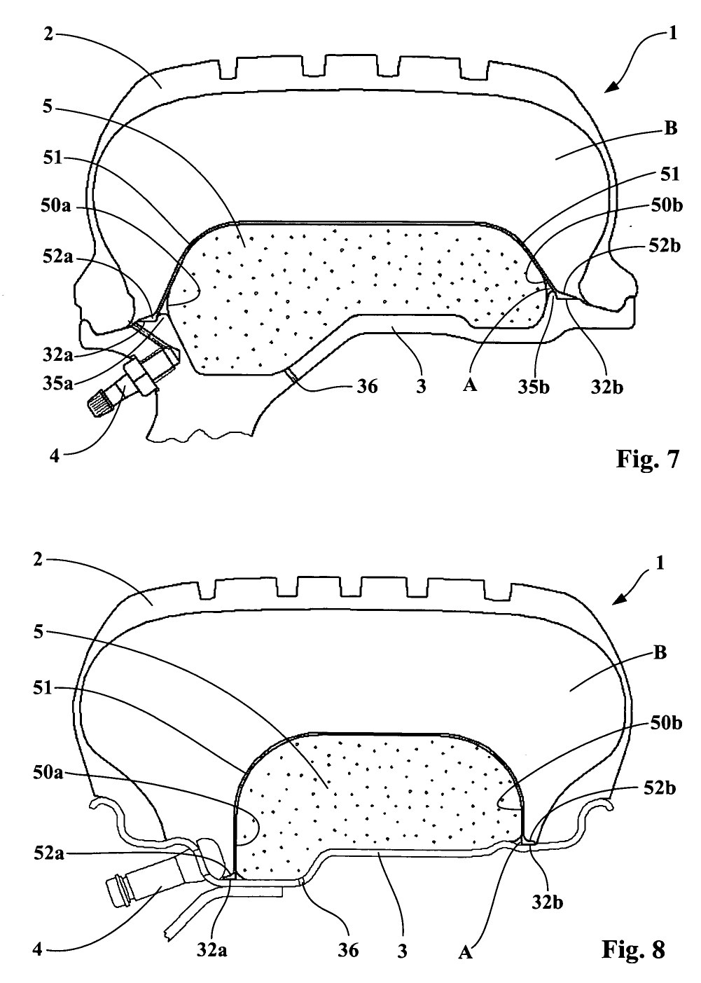

FIG. 7 proposes a third variant embodiment in which the edges 52a, 52b of the membrane 51 are resilient. An airtight seal with the circular bearing surface 32a, 32b is ensured by the combination of the resilient force clamping the edge 52a, 52b to the bearing surface 32a, 32b and by the pressure forces acting on the surface of the edge 52a, 52b. The resilient clamping force and the contact surface between the bearing surface 32a, 32b and the edge 52a, 52b of the membrane 51 have to be adapted to ensure airtight clamping and to oppose the effects of the centrifugal force whatever the speed at which the vehicle is travelling.

It will be noted that the rims of the wheels shown in FIGS. 1 to 7 have seats inclined outwards, as described for example in patent EP 637 324. These seats also have different diameters.

This type of assembly is particularly well adapted to running under reduced pressure and makes it possible to simplify the operations of mounting and demounting the tire and the foam insert comprising membranes whose edges comprise a circular reinforcement. However, the invention is not limited to this type of assembly and may also be implemented for an assembly taking the form of a wheel comprising conventional rim seats which are inclined inwards and adapted to receive the most common tires, as is illustrated in FIG. 8.

All these embodiments relating to the form taken by the membrane (51, 51a, 51b), or the form taken by the airtight joint between the edge (52a, 52b) of the membrane and the circular bearing surface (32a, 32b) may be combined in pairs, without departing from the spirit of the invention, as a function of the particular advantages which they may provide.

We claim:

1. An assembly (1) formed of a wheel, comprising:
a tire (2);
a rim (3) equipped with an inflation valve (4) and rim seats (31a, 31b) designed to receive the beads (21a, 21b) of the tire (2); and
a foam insert (5) placed inside the volume defined by the internal wall of the tire (2) and the wheel rim (3), in which assembly the foam insert (5) is disposed in a first compartment (A) in communication with the atmosphere via a duct (36) and isolated in airtight manner by a flexible membrane (51, 51a, 51b) from the rest of the space (B) inside the tire casing, which space forms a second compartment (B) in communication with the inflation valve (4, 41) and designed to be inflated to the utilisation pressure of the tire, wherein at least one of the edges of the membrane (52a, 52b) forms an airtight joint with the rim (3) along a circular bearing surface (32a, 32b), separate from the seats (31a, 31b) of the rim (3) and situated axially inside the space between a rim seat (31a, 31b) and the zone (37) of the rim (3) designed to receive the foam insert (5).

2. The assembly according to claim 1, in which the edge (52a, 52b) of the membrane (51, 51a, 51b) in contact with the circular bearing surface (32a, 32b) comprises a circular reinforcement (53a, 53b, 54a, 54b), the diameter of which is adapted to reinforce clamping of said edge (52a, 52b) of the membrane (51, 51a, 51b) on the circular bearing surface (32a, 32b).

3. The assembly according to claim 2, in which the edge (52a, 52b) of the membrane (51, 51a, 51b) is adhesively bonded to the radially upper bearing surface of a circular ring (54a, 54b).

4. The assembly according to claim 3, in which the circular bearing surface (32a, 32b) comprises a groove (33a, 33b) in which is disposed an O-ring seal (34a, 34b) forming an airtight joint with the radially lower bearing surface of the circular ring (54a, 54b).

5. The assembly according to claim 1, in which the edge (52a, 52b) of the membrane (51, 51a, 51b) in contact with the circular bearing surface (32a, 32b) has a modulus of elasticity and a surface adapted to ensure an airtight joint between said edge (52a, 52b) and the circular bearing surface (32a, 32b).

6. The assembly according to claim 1, in which the edge (52a, 52b) of the membrane (51, 51a, 51b) is adhesively bonded to the circular bearing surface (32a, 32b).

7. The assembly according to claim 1, in which the circular bearing surface (32a, 32b) comprises a limit stop (35a, 35b) which makes it possible to limit axial displacement of the edge (52a, 52b) of the membrane (51, 51a, 51b) in contact with the circular bearing surface (32a, 32b).

8. The assembly according to claim 1, in which the rim comprises two circular bearing surfaces (32a, 32b) situated axially on either side of the zone (37) of the rim (3) designed to receive the foam insert, and ensuring the airtight joint with each of the edges (52a, 52b) of the membrane (51, 51a,51b).

9. The assembly according to claim 1, in which one of the two edges (52b) of the membrane (51) is adhesively bonded to the internal wall of the bead (21b) of the tire (2).

10. The assembly according to claim 9, in which the edge (52b) of the membrane (51) adhesively bonded to the internal wall of the bead (21b) is situated axially on the opposite side from the side comprising the orifice of the inflation valve (4) leading into the second compartment (B).

11. The assembly according to claim 1, in which the membrane (51a, 51b) is separated into two parts, whose axially inner edges are adhesively bonded in airtight manner to each of the sidewalls (50a, 50b) of the foam insert (5).
